(19) United States
(12) Patent Application Publication
(10) Pub. No.: US 2020/0038977 A1
(43) Pub. Date: Feb. 6, 2020

(54) CUTTING DEVICE

(71) Applicant: The Green Twist LLC, Tenafly, NJ (US)

(72) Inventors: Hooman Azmi, Tenafly, NJ (US); Arman Azmi, Tenafly, NJ (US); Mazyar Azmi, Tenafly, NJ (US)

(21) Appl. No.: 16/529,324

(22) Filed: Aug. 1, 2019

Related U.S. Application Data
(60) Provisional application No. 62/713,240, filed on Aug. 1, 2018.

(51) Int. Cl. B23D 47/12; B27B 5/14

(52) U.S. Cl. CPC B23D 47/126; B27B 5/14

(57) ABSTRACT

A cutting device, including: a handle rotatable about a central axis; and at least one blade attached to the handle, a cutting edge of the at least one blade is at a first distance from the central axis; wherein the handle comprises an opening around the central axis configured to accommodate a protruded part on a surface to be cut. A method of using the cutting device is also disclosed.

### CROSS REFERENCE TO RELATED APPLICATIONS

This application claims the benefit of U.S. Provisional Application No. 62/713,240, filed Aug. 1, 2018, the contents of which are incorporated by reference herein.

### FIELD OF THE INVENTION

This invention relates generally to cutting equipment, and more particularly to a cutting device for removing the plastic spout on milk and juice cartons.

### BACKGROUND

Liquids, such as milk and juice, are sold in cartons made from cardboard or paper-like material, laminated with a plastic or a metal foil layer to make the cartons liquid-proof. To make it easy for dispensing the liquid, a spout is usually put on the carton.

In recent years, environmental concerns have prompted consumers to recycle a lot of containers, including milk and juice cartons. However, the spouts on the cartons are mostly made of some plastic materials that are different from the paper materials that make up the rest of the carton body. Thus, recycling this type of cartons would require an additional step of removing the spouts from the cartons for separate material recycling lines.

Cutting devices, such as box-cutters, knives, scissors, etc., may be used to remove the spout on a liquid carton. However, using such devices is cumbersome and dangerous, because of the fact that the geometry of the carton and the placement of the spout on the carton make the maneuvering of the cutter around the spout very awkward. Therefore, there is a need for a cutting device for removing the spouts from the liquid cartons easily and safely.

### SUMMARY

An embodiment of the present invention provides a cutting device, including: a handle rotatable about a central axis; and at least one blade attached to the handle, a cutting edge of the at least one blade is at a first distance from the central axis; wherein the handle comprises an opening around the central axis configured to accommodate a protruded part on a surface to be cut.

Another embodiment of the present invention provides a cutting method by using a cutting device, wherein the cutting device includes: a handle rotatable about a central axis, and at least one blade attached to the handle, a cutting edge of the at least one blade is at a first distance from the central axis, and wherein the handle includes an opening around the central axis configured to accommodate a protruded part on a surface to be cut, the method including: aligning the opening of the handle with the protruded part on the surface to be cut; allowing the protruded part to go through the opening and the cutting edge to make contact with the surface; and turning the handle about the central axis so as to cause the blade rotationally cutting the surface.

### BRIEF DESCRIPTION OF THE DRAWINGS

FIG. 1 shows two different perspective views of a cutter device with the cap on according to an embodiment.

FIG. 2 shows a perspective view of a cutter device with the cap off according to an embodiment.

FIG. 3 shows a perspective view of a cutter device with the cap off and the blades out according to an embodiment.

FIG. 4 shows a perspective view of a cutter device with the cap off with the blades screwed onto the cap according to an embodiment.

FIG. 5 shows an exploded view of a handle of a cutter device according to an embodiment.

FIG. 6 shows the front view and cross-sectional view of a handle of a cutter device according to an embodiment.

FIG. 7 shows an exploded view of a cutter blade cartridge according to an embodiment.

FIG. 8 shows the front view and cross-sectional view of a cutter blade cartridge with a cap according to an embodiment.

FIG. 9 shows the front view and side view of a cutter blade according to an embodiment.

FIG. 10 shows an exploded view of a cutter blade cartridge according to an embodiment.

FIG. 11 shows the top view, front view and cross-sectional view of a cutter blade cartridge with a cap according to an embodiment.

FIG. 12(A), FIG. 12(B), and FIG. 12(C) show different views of a cutter blade according to an embodiment.

FIG. 13 shows two different perspective views of a cutter device with the cap on according to an embodiment.

FIG. 14 shows a perspective view of a cutter device with the cap off according to an embodiment.

FIG. 15 shows an exploded view of a cutter device according to an embodiment.

FIG. 16(A), FIG. 16(B), FIG. 16(C) and FIG. 16(D) illustrates the steps of removing a spout with a cutter according to an embodiment.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

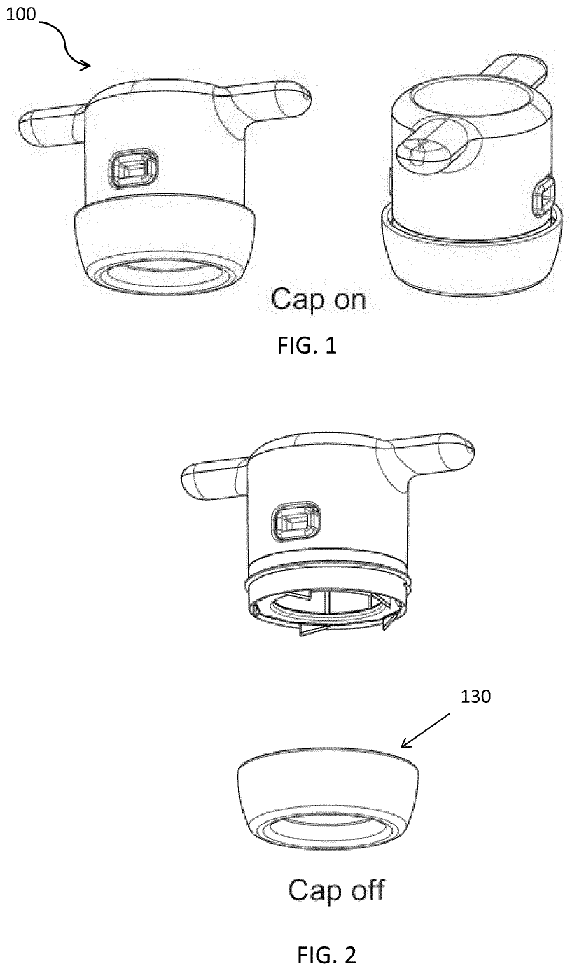

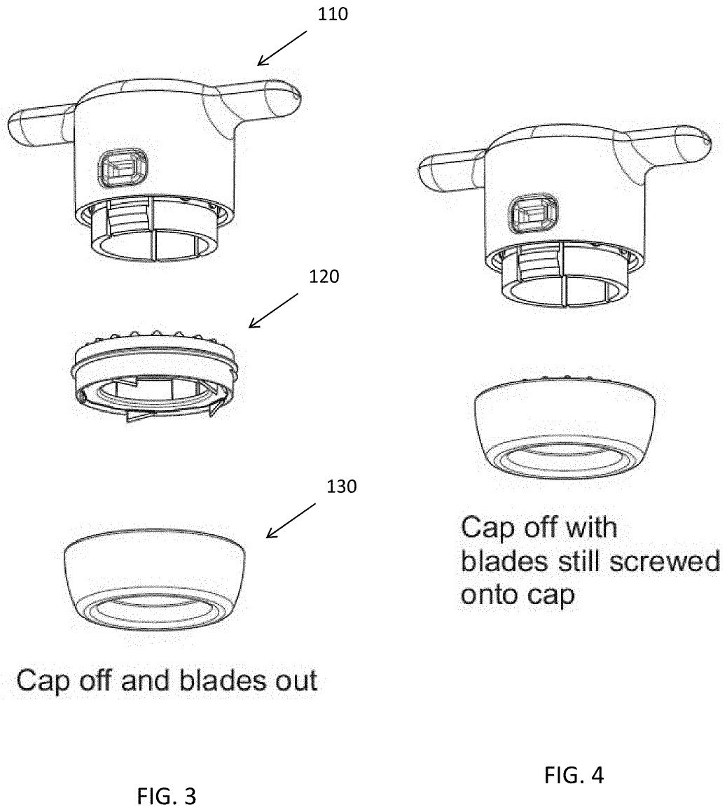

FIG. 1 shows a cutter 100 according to an embodiment of the present invention. In this embodiment, there is an optional cap 130 that covers the blades for safety when the cutter is not in used or in storage. FIG. 2 shows that the blades are exposed when the cap is taken off. In one embodiment, the blade cartridge 120 can be removed from the handle 110 as shown in FIG. 3. In one embodiment, the blade cartridge is screwed onto the cap as shown in FIG. 4. Other means of securing the blade cartridge onto the cap are also contemplated.

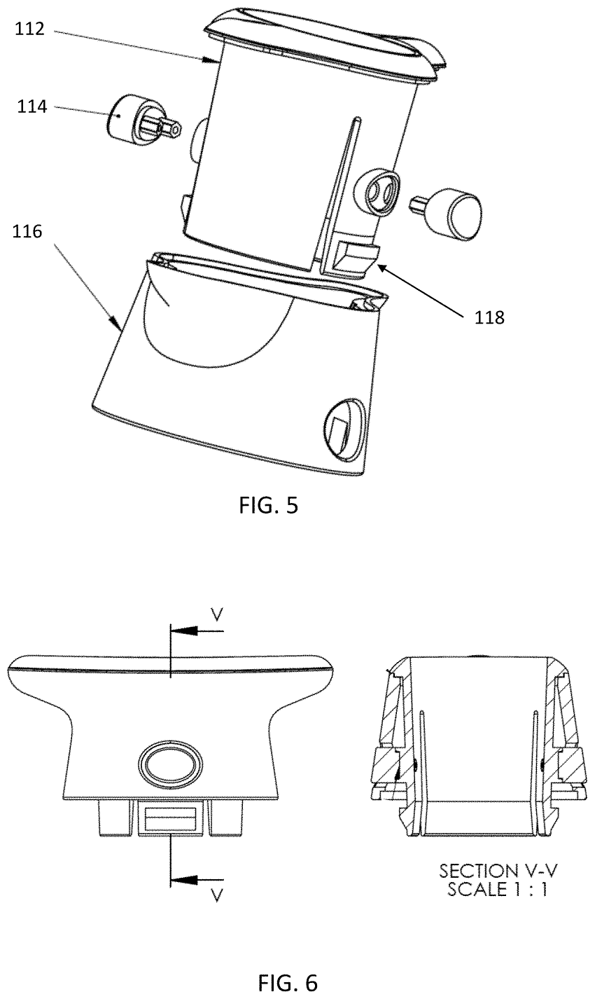

FIG. 5 is an exploded view of the cutter handle according to an embodiment. The handle includes a core 112, one or more buttons 114 and a housing 116. The core 112 fits into the housing 116 which has one or more holes to allow the one or more buttons 114 to project out of the housing. A blade cartridge is configured to be fixed to the handle via a fixing means, such as a snap-fit joint, a screw-thread joint, etc. In one embodiment, the core 112 includes one or more cantilever arms with a hook 118 configured as snap-fit joints to catch a mating part in a blade cartridge. To fix the blade cartridge to the handle, the handle is pushed into the blade cartridge with the cap. When the cap is removed, the cutter is ready for use. The blade cartridge may be removed for replacement. When the buttons 114 are pressed, the cantilever arms are bent inwards, releasing the snap-fit joints, and the blade cartridge is detached from the handle.

FIG. 6 shows the front view and cross-sectional view of the handle according to an embodiment. As can be seen from the figure, the core of the handle has a hollow center which would accommodate a protruding part on a surface to be cut, e.g., spout on a milk carton, such that when the cutter is place on top of the protruding part, the blade edges may make contact with the surface to be cut.

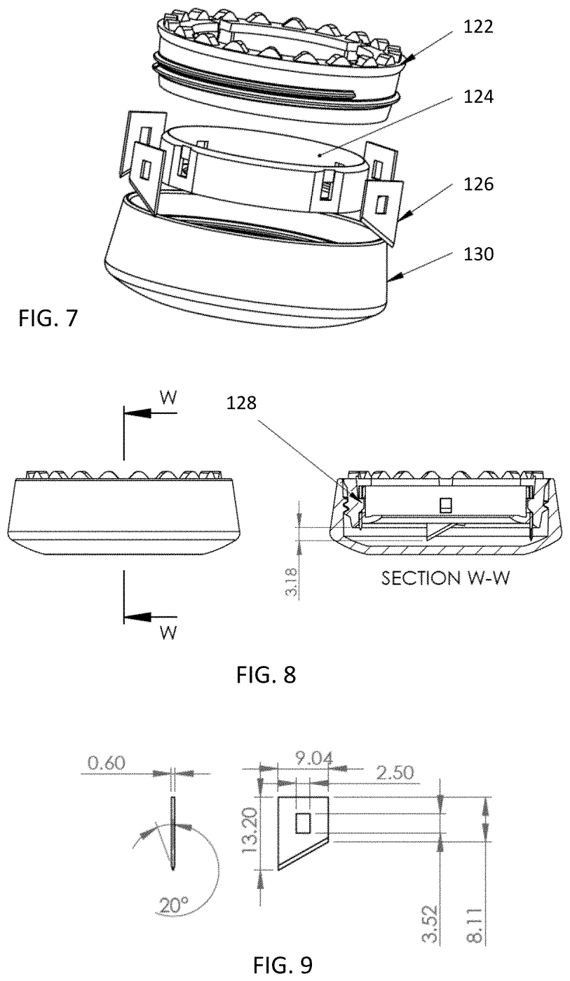

FIG. 7 is an exploded view of the blade cartridge according to an embodiment. The blade cartridge includes a blade outer housing 122. In one embodiment, the blade outer housing is threaded so as to screw onto the cap 130 having a matching threading. In one embodiment, the blade outer housing has teeth that match the corresponding teeth in the handle so as to transfer rotational force from the handle to the blades. FIG. 7 also shows that the blade inner housing has slots to accommodate one or more blades 126. In one embodiment, the blade 126 is made of stainless steel.

FIG. 8 shows the front view and cross-sectional view of the blade cartridge in the cap according to an embodiment. As can be seen from FIG. 8, the blade outer housing 112 has one or more hooks 128 configured as snap-fit joints to catch the holes on the blade 126 and on the blade inner housing 124. The snap-fit joints hold the blade outer housing 112, blade inner housing 124 and one or more blades 126 together to form the cutter blade cartridge. FIG. 9 shows the front and side views of the blade 124 with example dimensions according to an embodiment.

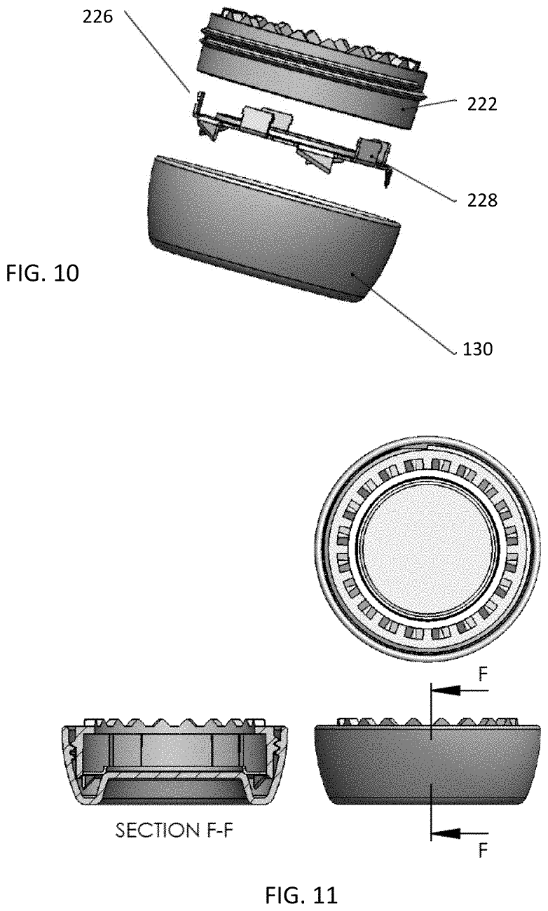

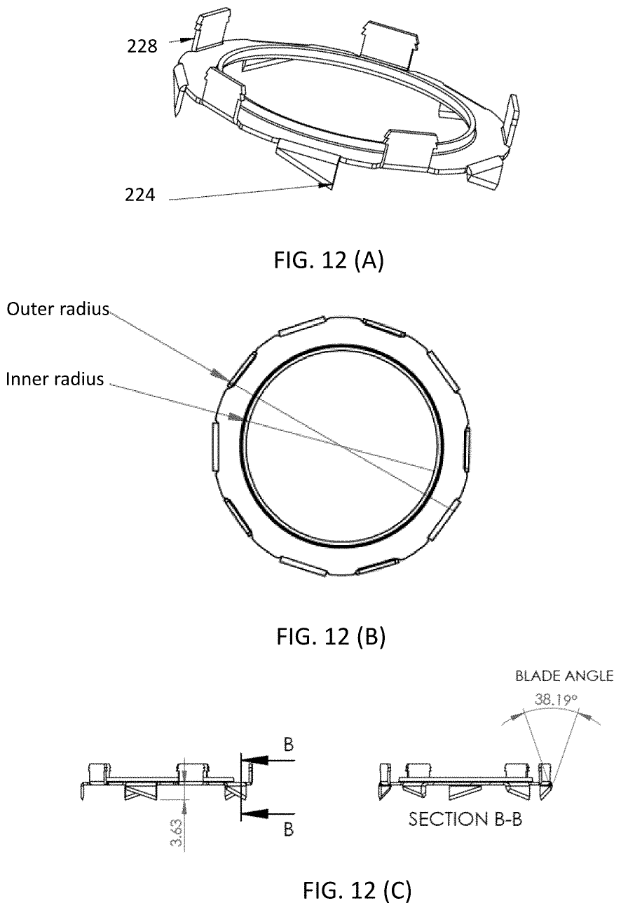

FIG. 10 is an exploded view of the blade cartridge according to another embodiment. The blade cartridge includes a blade outer housing 222 and a blade 226. FIG. 12(A) shows the perspective view of the blade 226, FIG. 12(B) shows the top view of the blade 226, and FIG. 12(C) shows the front and cross-sectional view of the blade 226 with example dimensions. The inner radius of the blade should be large enough to accommodate the protruding part on a surface to be cut. The outer radius should be large enough to cut beyond the flange of the spout inside the carton. In one embodiment, the blade 226 includes one or more cutting edges 224. In one embodiment, the blade 226 includes one or more tabs 228 configured to fit into corresponding slots in the blade outer housing 222. In one embodiment, the blade 226 is made of stamped stainless steel. FIG. 11 shows the top, front and cross-section views of the blade cartridge in the cap according to an embodiment.

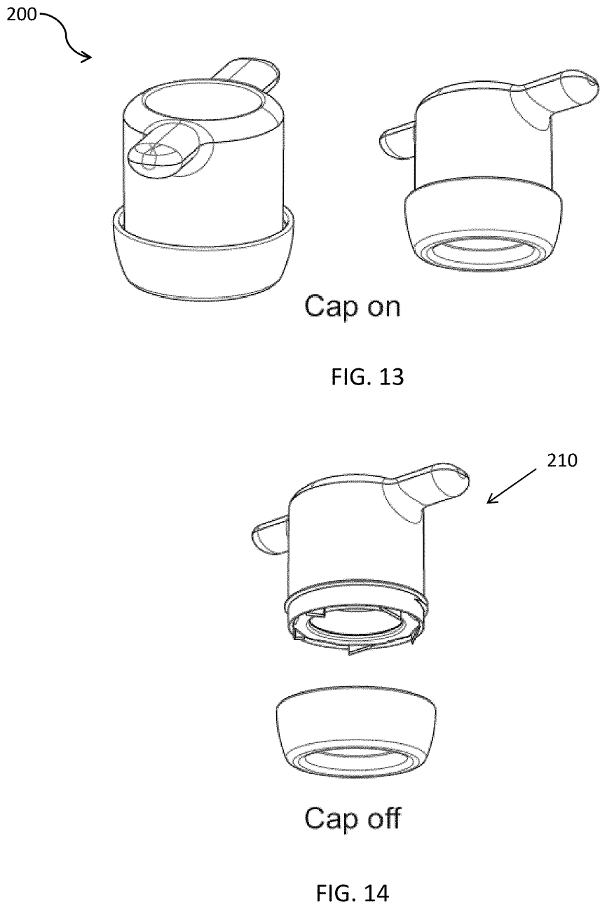

FIG. 13 shows a cutter 200 according to another embodiment of the present invention. There is an optional cap 130 that covers the blades for safety when the cutter is not in used or in storage. FIG. 14 shows that the blades are exposed when the cap is taken off. In this embodiment, the blade 226 is integrated to the handle.

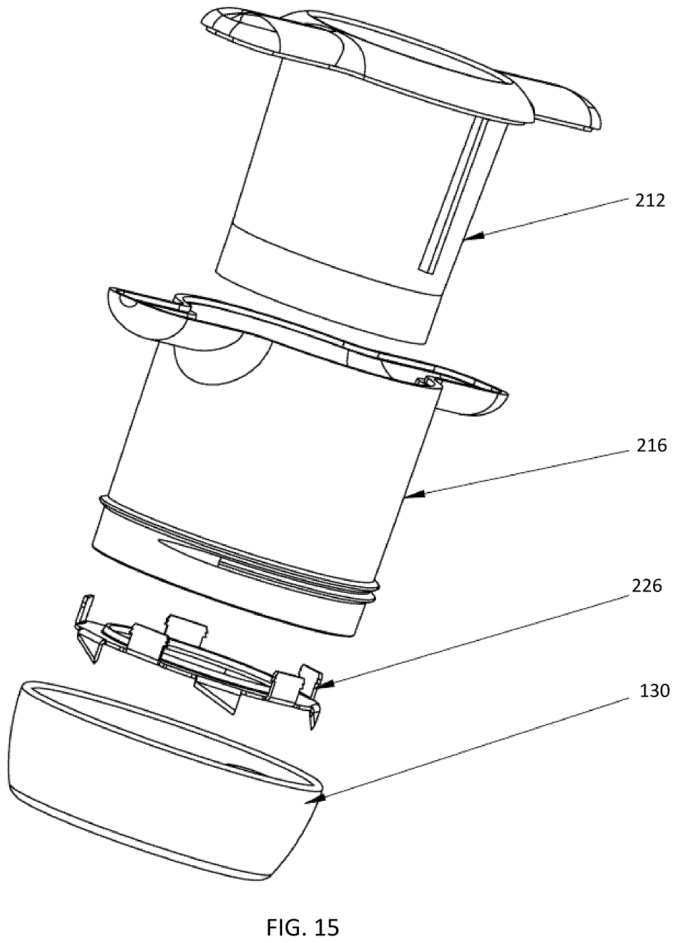

FIG. 15 shows an exploded view of a cutter device according to an embodiment. The handle 210 includes a core 212, and a housing 216. The core 212 fits into the housing 216. In one embodiment, the housing 216 is threaded so it can be screwed onto the cap 130. The blade 226 is similar to the one discussed above and shown in FIG. 12. In one embodiment, the blade 226 includes one or more tabs 228 configured to fit into corresponding slots in the housing 216.

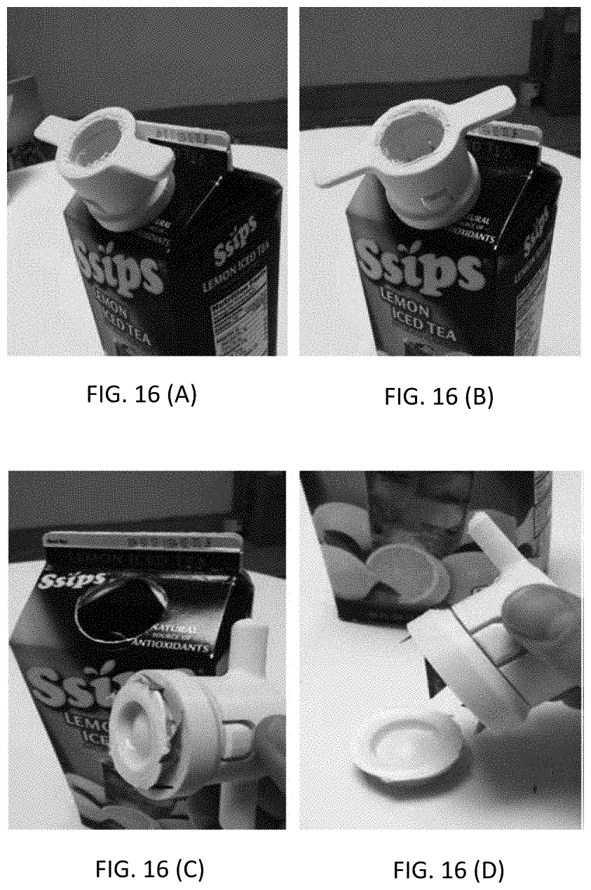

FIG. 16 illustrates the use of a cutter according to an embodiment. As shown in FIG. 16(A), the cutter is placed on top of the spout to be cut off. The spout passes through an opening in the handle so that the blade edges make contact with the carton. In FIG. 16(B), the handle is rotated, causing the blade to cut into the carton. As the blades complete cutting through the carton, the spout is removed as shown in FIG. 16(C). Note that due to friction, the spout stays in the hollow part of the handle after it has been cut off from the carton. In one embodiment, the handle has an opening on the opposite side, so that the spout may be pushed out of the handle.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A cutting device, comprising:
a handle rotatable about a central axis; and
at least one blade attached to the handle, a cutting edge of the at least one blade is at a first distance from the central axis;
wherein the handle comprises an opening around the central axis configured to accommodate a protruded part on a surface to be cut.

2. The cutting device of claim 1, wherein the cutting device comprises a plurality of blades, the cutting edge of each of the plurality of blades is at the first distance from the central axis.

3. The cutting device of claim 1, wherein the blade is integrally attached to the handle.

4. The cutting device of claim 1, wherein the blade is removablely attached to the handle.

5. The cutting device of claim 4, wherein the blade is arranged in a blade cartridge, the blade cartridge further comprises a blade housing.

6. The cutting device of claim 5, wherein the blade cartridge is attached to the handle by a snap-fit mechanism.

7. The cutting device of claim 5, wherein the blade is pressed into the blade housing by a snap-fit mechanism.

8. The cutting device of claim 4, wherein the handle comprises an outer housing and an inter housing, and the outer housing and the inter housing are matched each other to form the handle.

9. The cutting device of claim 8, wherein the inner housing comprises a button-shape projection at the lower end of the inner housing and the outer housing comprises a hole at the corresponding position of the button-shape projection, the outer housing and the inter housing are matched by the button-shape projection and the hole.

10. The cutting system of claim 9, wherein the inner housing is longer than that of the outer housing in the axial direction, and further comprises a projection under the button-shape projection so as to make the blade cartridge attached or detached from the handle by pressing the button-shape projection.

11. The cutting device of claim 1, which further comprises a protective lid for protection of the blade.

12. The cutting device of claim 11, wherein the protective lid is screwed onto the blade cartridge or pressed onto the blade cartridge by a snap-fit mechanism.

13. The cutting device of claim 1, wherein the blade comprises a plurality of cutting edges, each of the plurality of edges is at the first distance from the central axis.

14. A cutting method by using a cutting device, wherein the cutting device comprises:
a handle rotatable about a central axis, and at least one blade attached to the handle, a cutting edge of the at least one blade is at a first distance from the central axis, and wherein the handle comprises an opening around the central axis configured to accommodate a protruded part on a surface to be cut, the method comprising:
aligning the opening of the handle with the protruded part on the surface to be cut;
allowing the protruded part to go through the opening and the cutting edge to make contact with the surface; and
turning the handle about the central axis so as to cause the blade rotationally cutting the surface.
